(19) United States
(12) Patent Application Publication
(10) Pub. No.: US 2022/0388583 A1
(43) Pub. Date: Dec. 8, 2022

(54) TRACK SYSTEM AND VEHICLE

(71) Applicant: SOUCY INTERNATIONAL INC., Drummondville (CA)

(72) Inventor: Jeremie AUBIN-MARCHAND, St-Hugues (CA)

(21) Appl. No.: 17/830,392

(22) Filed: Jun. 2, 2022

Related U.S. Application Data
(60) Provisional application No. 63/195,863, filed on Jun. 2, 2021.

(51) Int. Cl. B62D 55/10; B62D 55/24

(52) U.S. Cl. CPC B62D 55/10; B62D 55/24

(57) ABSTRACT

A track system connectable to an axle of a vehicle has a track engaging assembly and an endless track. The track engaging assembly includes a frame, a drive wheel, front and rear idler wheel assemblies, a bogie assembly and a plurality of support wheel assemblies which includes leading, intermediate and trailing wheel assemblies that respectively apply leading, intermediate and trailing ground forces to a ground surface. A sum of the leading, intermediate and trailing ground forces defines a total ground force. The track system has an initial position wherein the total ground force is concentrated at the intermediate ground force, when the track system is at rest on a hard and flat level ground surface. In response to the bogie assembly pivoting about the bogie assembly axis, the total ground force is distributed between the intermediate ground force and at least one of the leading and trailing ground forces.

### CROSS-REFERENCE

This application claims the benefit of and priority to U.S. provisional patent application No. 63/195,863, filed on Jun. 2, 2021; the content of which is herein incorporated in entirety by reference.

### TECHNICAL FIELD

The present technology relates to track systems and vehicles having track systems.

### BACKGROUND

Certain off-road vehicles, such as all-terrain vehicles (ATVs and UTVs), may be equipped with track systems which enhance their traction and floatation on soft, slippery and/or irregular grounds (e.g., soil, mud, sand, ice, snow, etc.) on which they operate.

For instance, an ATV may be equipped with track systems in place of ground-engaging wheels with tires for which it may have been originally designed.

Replacement of the wheels by track systems provides a larger contact area (patch) on the ground compared to the size of the contact area (patch) of a wheel on the ground. Floatation over soft, slippery and/or irregular ground surfaces is increased and the lower portion of the vehicle is maintained at a greater distance from the ground surface.

Conventionally, track systems comprise a frame, a drive wheel, at least one idler wheel on at least one extremity of the frame, a plurality of support wheels, a tensioner, and an endless track disposed around the drive wheel, the at least one idler wheel, and the plurality of support wheels.

These track systems, while good, are not without their drawbacks. For one, the size of the contact patch also affects the ease of steering the vehicle. On a wheeled or tracked vehicle, the wheels that steer the vehicle are turned about a steering axis defined by the steering system of the vehicle. The contact area of the wheel or track that surrounds the steering axis projected on the ground of the steering wheels opposes, via friction, the rotational movement of the wheel or track about this steering axis. Thus, the larger the contact area on the ground, the more area there is to generate friction which opposes the movement about the pivot point, and the tougher it is to rotate the patch around the steering axis. Therefore, the larger contact area on the ground generated by a track system inherently increases the force needed to steer the vehicle, which is undesirable.

Another difficulty is that some track systems are typically made of components fixedly connected to a frame, which is pivotably connected to the vehicle. This prevents the track systems from following the shape of the uneven ground over which the vehicle is traveling, the traction provided being thus somewhat limited because the contact area of the endless track is not capable of adapting to the ground's imperfections.

In order to reduce the aforementioned drawbacks, there is a desire for a track system and a vehicle that mitigate the above-mentioned issues.

### SUMMARY

It is therefore an object of the present technology to ameliorate the situation with respect to at least one of the inconveniences present in the prior art.

It is also an object of the present technology to provide a track system and a vehicle having a track system that are improved at least in some instances as compared with some of the prior art.

In the context of the following description, “outwardly” or “outward” means away from a longitudinal center plane of the track system, and “inwardly” or “inward” means toward the longitudinal center plane. In addition, in the context of the following description, “longitudinally” means in a direction parallel to the longitudinal center plane of the track system in a plane parallel to flat level ground, “lateral”, “laterally”, “transverse” and “transversally” means in a direction perpendicular to the longitudinal center plane in a plane parallel to flat level ground, and “generally vertically” means in a direction contained in the longitudinal center plane along a height direction of the track system generally perpendicular to flat level ground. Note that in the Figures, a “+” symbol is used to indicate an axis of rotation. In the context of the present technology, the term “axis” may be used to indicate an axis of rotation. Also, the terms “pivot assembly” and “wheel assemblies” include all the necessary structure (bearing structures, pins, axles and other components) to permit a structure/wheel to pivot/rotate about an axis, as the case may be. Moreover, the direction of forward travel of the track system is indicated by an arrow in FIG. 1. In the following description and accompanying Figures, the track system is configured to be attached to a right side of the chassis of the vehicle. In the context of the present technology, the qualification of a wheel assembly as “at least indirectly connected” includes a wheel assembly that is directly connected to the at least one wheel-bearing frame member as well as a wheel assembly that is connected to the wheel-bearing frame member through an intermediate structure or structures, be they intermediate frame members or otherwise.

More particularly, according to an aspect of the present technology, there is provided a track system configured to be operatively connectable to a vehicle. The track system defines a longitudinal center plane and is operable on a ground surface. The track system includes a track-engaging assembly that has a frame, a drive wheel, a front idler wheel, a rear idler wheel, a bogie wheel assembly and a plurality of support wheel assemblies. The frame has a front portion, a rear portion, and a lower portion extending vertically below at least one of the front and rear portions. The drive wheel rotationally connected to the frame. The front idler wheel assembly is rotationally connected to the front portion of the frame. The rear idler wheel assembly is rotationally connected to the rear portion of the frame. The bogie assembly is pivotably connected to the lower portion of the frame about a bogie assembly axis extending transversally to the longitudinal center plane, and has a bogie body defining a leading axis, an intermediate axis and a trailing axis. The leading, intermediate and trailing axes extend transversally to the longitudinal center plane and are longitudinally spaced from each other. The plurality of support wheel assemblies include a leading support wheel assembly rotationally connected to the bogie body for rotating about the leading axis, the leading support wheel assembly applying a leading ground force to the ground surface, an intermediate support wheel assembly rotationally connected to the bogie body for rotating about the intermediate axis, the intermediate support wheel assembly applying an intermediate ground force to the ground surface, and a trailing support wheel assembly rotationally connected to the bogie body for rotating about the trailing axis the trailing support wheel assembly applying a trailing ground force to the ground surface. A sum of the leading, intermediate and trailing ground forces define a total ground force applied to the ground surface by the track system. The track system also includes an endless track disposed around the track-engaging assembly, the endless track having a ground-engaging outer side for engaging the ground surface and an inner side opposite to the ground-engaging outer side, the endless track being configured to be drivingly engaged by the drive wheel. The track system has an initial position wherein the total ground force is generally concentrated at the intermediate ground force in response to the track system being at rest on generally a hard and flat level ground surface. In response to the bogie assembly pivoting about the bogie assembly axis, the total ground force is distributed between the intermediate ground force and at least one of the leading and trailing ground forces in response to the track system travelling on a generally hard and uneven ground surface.

In some embodiments, the bogie assembly is pivotably connected to the frame such that the bogie assembly axis is coaxial with the intermediate axis.

In some embodiments, the intermediate axis is disposed longitudinally between the leading axis and the trailing axis.

In some embodiments, a diameter of a wheel of the intermediate support wheel assembly is greater than a diameter of a wheel of at least one of the leading and trailing support wheel assemblies.

In some embodiments, the intermediate axis is vertically lower than at least one of the leading axis and trailing axis.

In some embodiments, the leading, intermediate and trailing support wheel assemblies are substantially aligned in a direction transversal to the endless track.

In some embodiments, at least one of the leading, intermediate and trailing support wheel assemblies includes more than one wheel assembly in a direction transversal to the endless track.

In some embodiments, the leading axis and the trailing axis are respectively spaced from the intermediate axis by a first distance and a second distance.

In some embodiments, a distance ratio of the first distance over the second distance is 1.

In some embodiments, a distance ratio of the first distance over the second distance is smaller than 1.

In some embodiments, a distance ratio of the first distance over the second distance is greater than 1.

In some embodiments, wherein the total ground force is distributed between the leading ground force and the trailing ground force according to the distance ratio in response to the leading support wheel assembly climbing on an obstacle of the ground surface or in response to the trailing support wheel assembly descending an obstacle of the ground surface.

In some embodiments, a magnitude of the leading ground force is greater than a magnitude of the trailing ground force in response to the vehicle accelerating.

In some embodiments, a magnitude of the leading ground force is lower than a magnitude of the trailing ground force in response to the vehicle decelerating.

In some embodiments, the front idler wheel assembly and the rear idler assembly are positioned above the hard and flat level ground surface.

In some embodiments, an approach angle between the endless track and the hard and flat level ground surface in front of the leading support wheel assembly is substantially equal to a departure angle between the endless track and the hard and flat level ground surface behind the trailing support wheel assembly.

In some embodiments, the track system further includes a tensioner associated with one of the front idler wheel assembly and the rear idler wheel for maintaining a tension of the endless track constant notwithstanding pivotal movement of the bogie assembly.

In some embodiments, the track system further includes a slide member extending adjacent to the plurality of support wheel assemblies, the slide member being spaced from the inner side of the endless track by a gap.

In some embodiments, the slide member is connected to the frame.

In some embodiments, the slide member is connected to the bogie assembly.

In some embodiments, the bogie assembly is pivotably connected to the frame via a resilient body structured and configured for permitting pivotal motion of the bogie assembly relative to the frame upon deformation of the resilient body.

In some embodiments, the pivotal motion of the bogie assembly relative to the frame is about a transversal axis.

In some embodiments, the pivotal motion of the bogie assembly relative to the frame is about a longitudinal axis.

In some embodiments, at least one of the leading, intermediate and trailing support wheel assemblies is rotationally connected to the bogie assembly via a resilient pivot structured and configured for permitting pivotal motion of at least one of the leading, intermediate and trailing support wheel assemblies relative to the bogie assembly about a longitudinal axis.

In some embodiments, an angular range of the pivotal motion of the at least one of the leading, intermediate and trailing support wheel assemblies relative to the bogie assembly is at least 3 degrees.

In some embodiments, the track system is operatively connected to an axle of the vehicle. In some embodiments, the axle is a drive axle.

In some embodiments, the track system is steerable by a steering system of the vehicle defining a steering axis to change an orientation of the track system relative to the vehicle.

In some embodiments, the intermediate axis extends behind a projection of the steering axis.

In some embodiments, the endless track is an elastomeric track.

In some embodiments, the track system is configured for operative connection to a vehicle being one of an ATV or a UTV.

In another aspect of the present technology, there is provided a vehicle having the track system connector according to the above aspect or according to the above aspect and one or more of the above embodiments.

In some embodiments, the vehicle is an ATV or an UTV.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic left side elevation view of a tracked off-road vehicle having two front track systems in accordance with an embodiment of the present technology, and two rear track systems;

FIG. 2 is a schematic top plan view the off-road vehicle of FIG. 1;

FIG. 3 is a perspective view taken from atop, rear, left side of a portion of the front, right track system of the off-road vehicle of FIG. 1;

FIG. 4 is a rear elevation view of the components of the track system of FIG. 3;

FIG. 5 is a perspective view taken from a bottom, front, right side of the track system of FIG. 3;

FIG. 6 is a right side elevation view of the complete front, right track system of the off-road vehicle of FIG. 1 resting on a hard and flat level ground surface;

FIG. 7 is a left side elevation view of the track system of FIG. 6;

FIG. 8 is a schematic right side elevation view of the track system of FIG. 6;

FIG. 9 is a schematic right side elevation view of the track system of FIG. 8 with a leading support wheel assembly of a bogie assembly of the track system of FIG. 8 engaging an obstacle;

FIG. 10 is a schematic right side elevation view of the track system of FIG. 8 with an intermediate support wheel assembly of the bogie assembly engaging the obstacle;

FIG. 11 is a schematic right side elevation view of the track system of FIG. 8 with a trailing support wheel assembly of the bogie assembly engaging the obstacle;

FIG. 12 is a schematic right side elevation view of the track system of FIG. 8 travelling on a soft surface, when the off-road vehicle accelerates;

FIG. 13 is a schematic view taken from a right side of the track system of FIG. 8 travelling on a soft surface, when the off-road vehicle decelerates;

FIG. 14 is a schematic right side elevation view of a track system according to another embodiment of the present technology, the track system having a bogie assembly, a frame and a resilient body between the bogie assembly and the frame;

FIG. 15A is a schematic right side elevation view of a portion of a bogie assembly according to another embodiment of the present technology, showing a support wheel assembly and a resilient pivot between the support wheel assembly and the portion of the bogie assembly;

FIG. 15B is a schematic cross-sectional view taken from a right side of the portion of the bogie assembly of FIG. 15A, showing the support wheel assembly and a first resilient pivot between the support wheel assembly and the portion of the bogie assembly, and a second resilient pivot between the portion of the bogie assembly and the frame;

FIG. 16A is a schematic, close-up right side elevation view of a portion of an alternate embodiment of a bogie assembly according to the present technology where a trailing support wheel assembly of the bogie assembly engages an obstacle; and

FIG. 16B is a schematic, close-up right side elevation view of the portion of the bogie assembly of FIG. 16A, with a slide member being shown in phantom lines.

### DETAILED DESCRIPTION

The description of the present technology, which relates to various embodiments of a track system having a bogie assembly and a vehicle equipped with the track system, is intended to be a description of illustrative examples of the present technology.

It is to be expressly understood that the various embodiments of the track system and of the vehicle are merely embodiments of the present technology. Thus, the description thereof that follows is intended to be only a description of illustrative examples of the present technology. This description is not intended to define the scope or set forth the bounds of the present technology. In some cases, what are believed to be helpful examples of modifications or alternatives to apparatus may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing or embodying that element of the present technology. As a person skilled in the art would understand, this is likely not the case. In addition, it is to be understood that the apparatus may provide in certain aspects a simple embodiment of the present technology, and that where such is the case it has been presented in this manner as an aid to understanding. As persons skilled in the art would understand, various embodiments of the present technology may be of a greater complexity than what is described herein.

### Off-Road Vehicle

The present technology will be described with reference to an off-road vehicle 10. The off-road vehicle 10, as presented herein, is referred to as a vehicle designed for carrying or transporting something or someone by traveling on different types of grounds, including hard and flat level surfaces, soft surfaces, uneven surfaces, un-prepared surfaces, slippery surfaces, and/or irregular surfaces. It is understood that the off-road vehicle 10 can be different type of vehicles, such as but without being limited to motorized vehicles (agricultural vehicles, industrial vehicles, recreational vehicles, utilitary vehicles, military vehicles, robotic vehicles, exploration vehicles, etc.) or non-motorized or towed vehicles (trailers, carts, etc.) having at least one axle to which a track system is connectable.

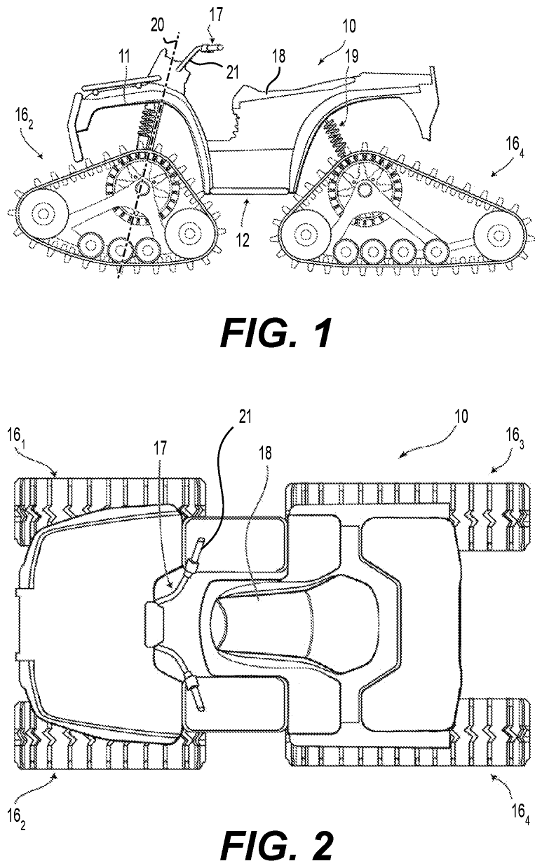

Referring to FIGS. 1 and 2, the off-road vehicle 10 is a tracked all-terrain vehicle (ATV) 10. As mentioned above, it is contemplated that the off-road vehicle could be a utility-task vehicle (UTV). In the embodiment shown, the ATV 10 has a vehicle chassis 11, a powertrain 12, a steering system 17 defining a steering axis 20, a suspension system 19 and a straddle seat 18. The ATV 10 also has two front track systems 16₁-16₂ in accordance to an embodiment of the present technology as well as two rear track systems 16₃-16₄, such that the ATV 10 has four track systems 16₁, 16₂, 16₃, 16₄ that are operatively connected to axles of the vehicle 10. It is contemplated that in other embodiments, the ATV 10 could have more or less than four track systems.

As discussed below, in various embodiments, the track systems 16₁-16₄ may have various features to enhance their traction and/or other aspects of their use and/or performance, such as, for example, features to ameliorate their maneuverability, to better adapt to ground, and/or to improve overall ride quality.

The powertrain 12 is configured to generate motive power and transmit said motive power to the track systems 16₁, 16₂, 16₃, 16₄ to drive the ATV 10. It is contemplated that in some embodiments, the powertrain 12 could only transmit motive power to some of the track systems 16₁, 16₂, 16₃, 16₄ (i.e. only to the rear track systems 16₃, 16₄). The steering system 17 is configured to enable an operator of the ATV 10 to steer the ATV 10. To this end, the steering system 17 includes a handlebar 21 that is operable by the operator to direct the ATV 10 along a desired course. In other embodiments, the handlebar 21 could be replaced by another steering device such as, for example, a steering wheel. In response to the handlebar 21 being steered, the track systems 16₁-16₂ pivot about the corresponding steering axis 20, thereby changing the orientation of the track systems 16₁-16₂ relative to the vehicle chassis 11, thus causing the ATV 10 to turn in given direction.

Referring to FIG. 1, the suspension system 19 is connected between the vehicle chassis 11 and the track systems 16₁-16₄ to allow relative motion between the vehicle chassis 11 and the track systems 16₁-16₄. The suspension system 19 enhances handling of the ATV 10 by absorbing shocks and helping to maintain traction between the track systems 16₁-16₄ and the ground.

The track systems 16₁-16₄ engage the ground to provide traction and floatation to the ATV 10. More particularly, the front track systems 16₁-16₂ provide front traction to the ATV 10, and the rear track systems 16₃-16₄ provide rear traction to the ATV 10. Similarly, the front track systems 16₁-16₂ provide front floatation to the ATV 10 while the rear track systems 16₃-16₄ provide rear floatation to the ATV 10.

### Track System

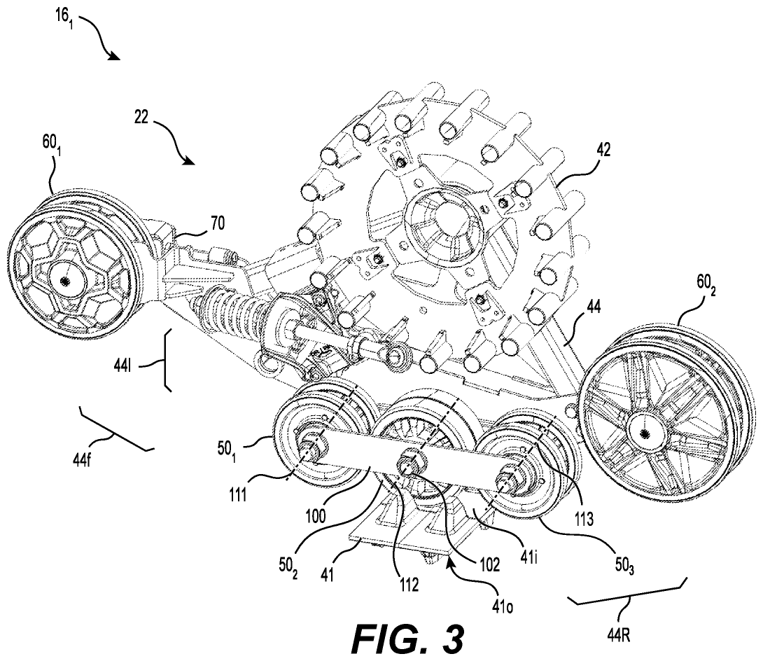

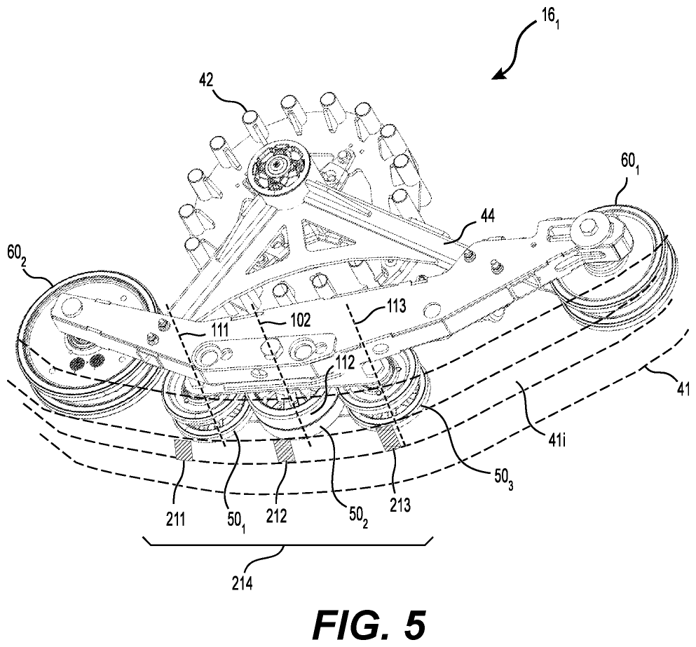

With reference to FIGS. 3 to 7, the track systems 16₁-16₂ will now be described in greater detail. The track system 16₁ is a front right track system to be connected to a front right side of the ATV 10, and the track system 16₂ is a front left track system to be connected to a front left side of the ATV 10. It is contemplated that in some embodiments, the front right and left track systems 16₁-16₂ could be connected to replace front left and right wheels of a wheeled ATV. The track system 16₁ and the track systems 16₂ are symmetric. As the track systems 16₁-16₂ are similar, only the track system 16₁ will be described in detail. Though the present technology is described with reference to front track systems 16₁-16₂, it is understood that the present technology is generally applicable to rear track systems, such as the track systems 16₃ and 16₄, unless otherwise specified.

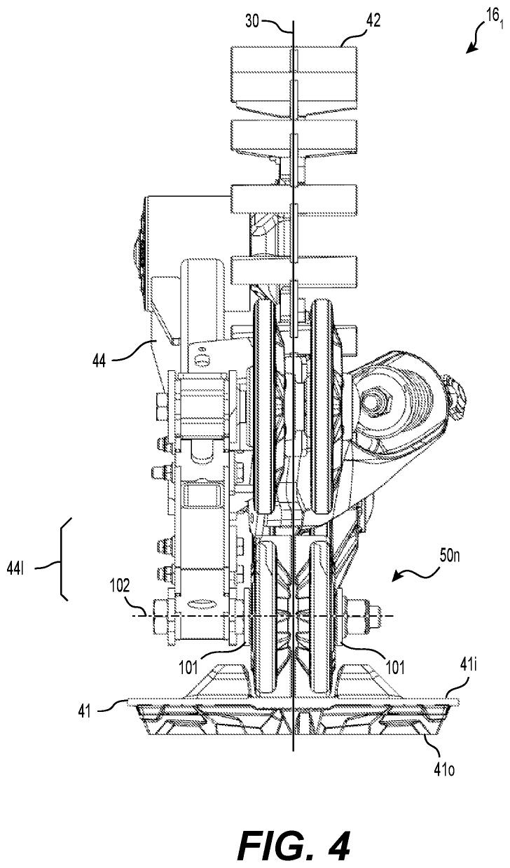

The track system 16₁, which defines a longitudinal center plane 30 (FIG. 4), has a track-engaging assembly 22 that extends generally along the longitudinal center plane 30. The track system 16₁ also has an endless track 41 disposed around the track-engaging assembly 22. The track-engaging assembly 22 has a frame 44, a drive wheel 42, a front idler wheel assembly 60₁, a rear idler wheel assembly 60₂, a bogie assembly 100, a leading support wheel assembly 50₁, an intermediate support wheel assembly 50₂, a trailing support wheel assemblies 50₃ and a tensioner 70. It is understood that in other embodiments, the track engaging assembly 22 could have more or less features than those listed above. For instance, in some embodiments, there could be more than three support wheel assemblies.

The endless track 41, has a ground-engaging outer side 41ₒ and an inner side 41ᵢ that is opposite to the ground-engaging outer side 41ₒ. The inner side 41ᵢ is configured to be drivingly engaged with the drive wheel 42. The endless track 41 is an elastomeric track. It is contemplated that in other embodiments, the endless track 41 could be constructed of a wide variety of materials and structures including metallic components.

Referring to FIG. 3, the frame 44, which has a front portion 44f, a rear portion 44r, and a lower portion 441, supports components of the track system 16₁, including the drive wheel 42, the bogie assembly 100, the leading, intermediate and trailing support wheel assemblies 50₁-50₃ and the front and rear idler wheel assemblies 60₁-60₂. More particularly, in the present embodiment, the drive wheel 42 is rotationally connected to the frame 44, the front idler wheel assembly 60₁ is rotationally connected to the front portion 44f of the frame 44, the rear idler wheel assembly 60₂ is rotationally connected to the rear portion 44r of the frame 44 and the bogie assembly 100, to which the leading, intermediate and trailing support wheel assemblies 50₁-50₃ are connected, is pivotably connected to the lower portion 441 of the frame 44, and is disposed between the front and rear idler wheel assemblies 60₁-60₂ such that the front and rear idler wheel assemblies 60₁-60₂ are positioned vertically above the bogie assembly 100.

The tensioner 70 is operatively connected to the front idler wheel assembly 60₁. The tensioner 70 maintains a tension of the endless track 41 constant notwithstanding pivotal movement of the bogie assembly 100. It is contemplated that in some embodiments, the tensioner 70 could be operatively connected to the rear idler wheel assembly 60₂.

### Bogie Assembly

As best seen in FIG. 3, the bogie assembly 100 is pivotably connected to the lower portion 44l of the frame 44 about a bogie assembly axis 102, such that the bogie assembly 100 is free to pivot relative to the frame 44 about the bogie assembly axis 102 by an angular range of motion of 15 degrees clockwise and 15 degrees counterclockwise. It is contemplated that in other embodiments, the angular range of motion could be different. For instance, the angular range of motion could be 10 degrees, 5 degrees or 3 degrees in one or both directions. In yet other embodiments, the angular range of motion could be more than 15 degrees in one or both directions. As will be described in greater detail below, the pivotal motion of the bogie assembly 100 can assist the track system 16₁ to overcome obstacles, better conform to the asperities of the ground, enhancing the traction, the ride quality and the maneuverability of the track system 16₁, under certain circumstances.

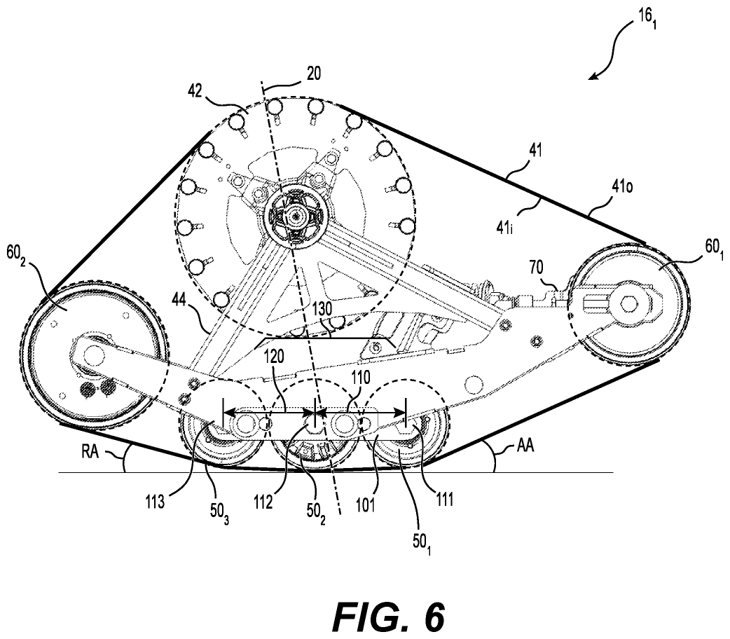

The bogie assembly 100 has a bogie body 101 extending in front of and behind the bogie assembly axis 102. The bogie body 101 defines a leading axis 111, an intermediate axis 112, and a trailing axis 113. The leading, intermediate and trailing axes 111, 112, 113 are generally transversal to the longitudinal center plane 30. In the present embodiment, the intermediate axis 112 is coaxial with the bogie assembly axis 102. As shown in FIG. 6, the track system 16₁ and the bogie assembly 100 are configured such that the intermediate axis 112, and thus the bogie assembly axis 102, is longitudinally offset from a projection (shown as a dashed line) of the steering axis 20. More precisely, the intermediate axis 112 extends behind the projection of the steering axis 20. It is contemplated that in some embodiments, the intermediate axis 112 could be in front of the projection of the steering axis 20. It is also contemplated that in some embodiments, the intermediate axis 112 could be aligned with the projection of the steering axis 20. The intermediate axis 112 being longitudinally offset from a projection of the steering axis 20 can facilitate and/or stabilize the maneuverability of the track system 16₁.

The leading axis 111 extends in front of the intermediate axis 112, and is longitudinally spaced therefrom by a distance 110 (FIG. 6). The trailing axis 113 extends behind the intermediate axis 112, and is longitudinally spaced therefrom by a distance 120. A distance ratio 130 is defined by the distance 110 over the distance 120. In some embodiments, the distance 110 and the distance 120 are substantially equal, such that the distance ratio 130 is about 1. In other embodiments, the distance 110 is shorter than the distance 120, such that the distance ratio 130 could be less than 1. In yet other embodiments, the distance 110 could be greater than the distance 120, such that the distance ratio 130 could be greater than 1.

The bogie body 101 has the leading, intermediate and trailing support wheel assemblies 50₁-50₃ connected thereto. The leading support wheel assembly 50₁ is rotationally connected to the bogie body 101 about the leading axis 111, the intermediate support wheel assembly 50₂ is rotationally connected to the bogie body 101 about the intermediate axis 112 and the trailing support wheel assembly 50₃ is rotationally to the bogie body 101 about the trailing axis 113. In the present embodiment, as mentioned above, the leading, intermediate and trailing support wheel assemblies 50₁-50₃ are disposed vertically below the front and rear idler wheel assemblies 60₁-60₂. In the present embodiment, each of the leading, intermediate, and trailing support wheel assemblies 50₁-50₃ includes two laterally spaced wheels. It is contemplated that in some embodiments, each of the leading, intermediate, and trailing support wheel assemblies 50₁-50₃ could only have a single wheel in the transversal direction of the track system 16₁. In some embodiments, at least two of the leading, intermediate and trailing support wheel assemblies 50₁-50₃ are substantially aligned in the transversal direction of the track system 16₁. In some embodiments, the leading, intermediate and trailing support wheel assemblies 50₁-50₃ are substantially aligned in a direction transversal to the track system 16₁.

In some embodiments, the intermediate support wheel assembly 50₂ could be directly rotationally connected to the lower portion 44l of the frame 44 between the front idler wheel assembly 60₁ and the rear idler wheel assembly 60₂.

As mentioned above, when the track system 16₁ rests on a hard and flat level surface, the front and rear idler wheel assemblies 60₁-60₂ are positioned vertically above the hard and flat level surface and the leading, intermediate and trailing support wheel assemblies 50₁-50₃. Thus, an approach angle AA is formed between the endless track 41 and the hard and flat level surface in front of the leading support wheel assembly 50₁ (shown in FIG. 6), and a departure angle RA is formed between the endless track 41 and the hard and flat level surface behind the trailing support wheel assembly 50₃. In some embodiments, the approach angle AA and the departure angle RA could be substantially equal.

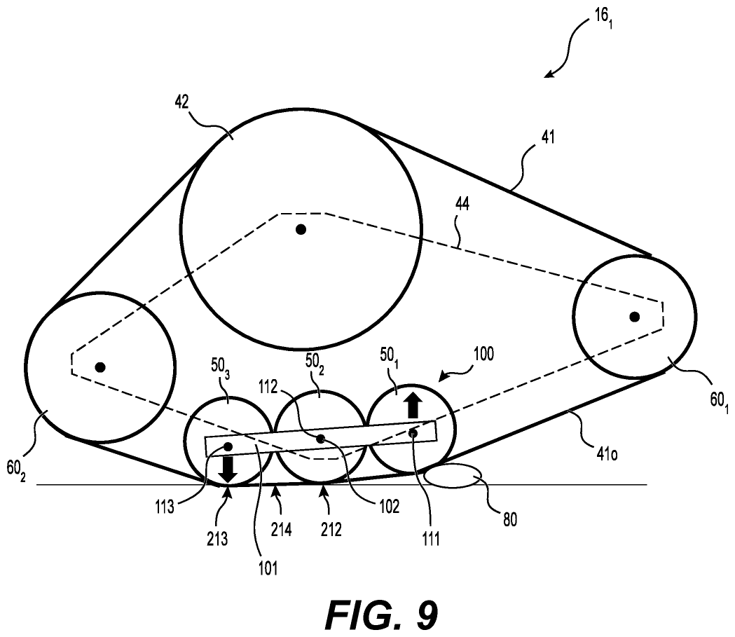

Referring to FIGS. 9 to 11, the leading support wheel assembly 50₁ defines a leading ground force 211, the intermediate support wheel assembly 50₂ defines an intermediate ground force 212 and the trailing support wheel assembly 50₃ defines a trailing ground force 213. The leading, intermediate and trailing ground forces 211, 212, 213 correspond to the magnitude of load respectively applied by the leading, intermediate, and trailing support wheel assemblies 50₁-50₃ on a surface of contact of the inner side 41ᵢ of the endless track 41. The loads applied by the leading, intermediate, and trailing support wheel assemblies 50₁-50₃ correspond to a portion of the overall weight of the ATV 10. It is understood that the loads applied by the leading, intermediate, and trailing support wheel assemblies 50₁-50₃ may be different from one another. It is further understood that the overall weight of the ATV 10 may not be equally distributed among the track systems 16₁-16₄ (i.e. the front track systems 16₁-16₂ could have more or less weight distributed thereto than the rear track systems 16₃-16₄). Thus, the sum of the leading, intermediate and trailing ground force 211, 212, 213 defines a total ground force 214 borne by the track system 16₁ when the track system 16₁ rests on a hard and flat level surface.

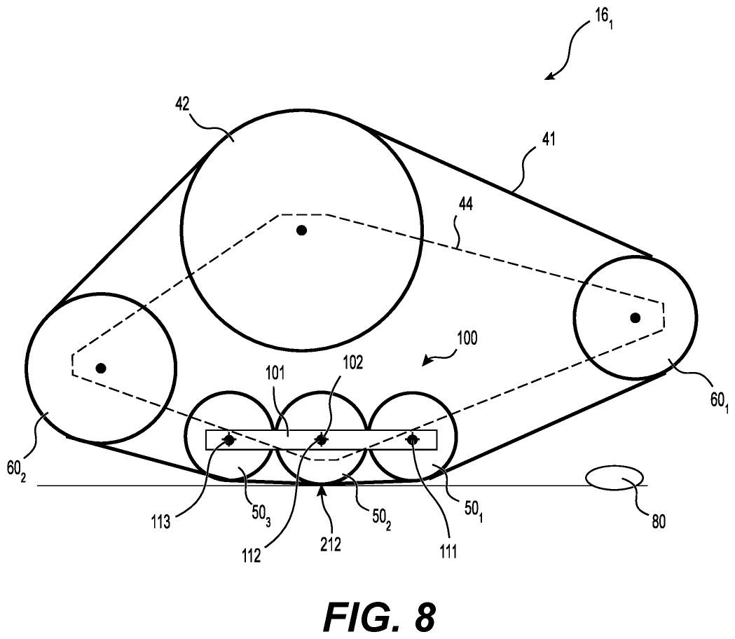

The track system 16₁ is configured such that the total ground force 214 is concentrated at the intermediate ground force 212 when the track system 16ᵢ is at rest on a hard and flat level surface. Thus, as best seen in FIG. 8, a lowermost portion of the intermediate support wheel assembly 50₂ extends lower than the lowermost portions of the leading and trailing support wheel assemblies 50₁, 50₃. To this end, in some embodiments, a diameter of the intermediate support wheel assembly 50₂ could be greater than the diameter of one or both of the leading and trailing support wheel assemblies 50₁, 50₃. In other embodiments, the intermediate axis 112 could be vertically lower than one or both of the leading axis 111 and the trailing axis 113. Having a total ground force 214 concentrated at the intermediate support wheel 212 can contribute to reducing the steering effort.

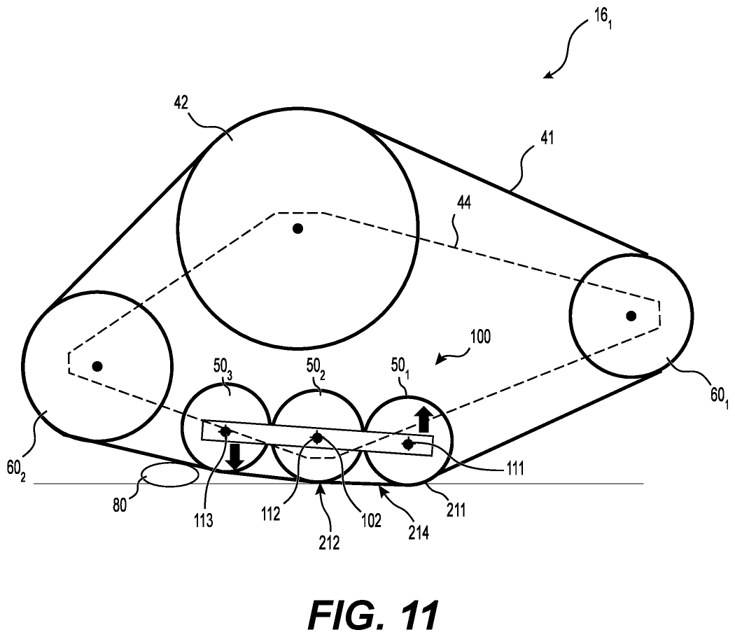

As mentioned above, the bogie assembly 100 is free to pivot about the bogie assembly axis 102 such that when the track system 16₁ is travelling on a hard and uneven surface and encounters an obstacle 80 (schematically shown in the Figures), the bogie assembly 100 acts as a rocker. As such, when one of the leading support wheel assembly 50₁ and the trailing support wheel assembly 50₃ moves in a direction (e.g. moving up), the other one of the leading support wheel assembly 50₁ and the trailing support wheel assembly 50₃ moves in an opposite direction (e.g. moving down), and vice versa. Arrows in FIGS. 9 and 11 show the movement of the leading and trailing support wheel assemblies 50₁, 50₂. It is understood that, depending of the distance ratio 130, the respective magnitude of the movement (i.e. relative deplacement) of the leading support wheel assembly 50₁ and of the trailing support wheel assembly 50₃ may differ in some cases. Thus, since, as explained above, the intermediate support wheel assembly 50₂ constantly applies the intermediate ground force 212, the total ground force 214 is distributed between the intermediate ground force 212 and one of the leading ground force 211 and the trailing ground force 213, depending of the rotational position of the bogie assembly 100 relative to the frame 44 and of the distance ratio 130.

### Track System in Operation

Referring to FIGS. 8 to 11, a description of the track system 16₁ overcoming an obstacle 80 will now be provided. In the present embodiment, the obstacle 80 is a rock 80.

Referring to FIG. 8, the track system 16₁ is travelling in a forward direction, driven by the sprocket wheel assembly 42. As mentioned above, in an initial position, the lowermost portion of the intermediate support wheel assembly 50₂ extends lower than the lowermost portions of the leading and trailing support wheel assemblies 50₁, 50₃ such that the total ground force 214 is mostly distributed in the intermediate ground force 212. Having the total ground force 214 concentrated at the intermediate support wheel 212 can assist in reducing the steering effort.

Referring now to FIG. 9, the track system 16₁ has encountered the rock 80. The rock 80 has come into contact with the ground-engaging outer side 41ₒ, below the leading support wheel assembly 50₁. The rock 80 causes the leading support wheel assembly 50₁ to climb on the rock 80 such that the leading support wheel assembly 50₁ moves in an upwards direction. The leading support wheel assembly 50₁ moving in the upwards direction causes the bogie assembly 100 to pivot counterclockwise such that the trailing support wheel assembly 50₃ move in a downwards direction (as represented by the arrows in FIG. 9). At this point, the total ground force 214 is mostly distributed between the intermediate ground force 212 and the trailing ground force 213. The pivotal motion of the bogie assembly 100 aids the track system 16₁ to overcome the rock 80.

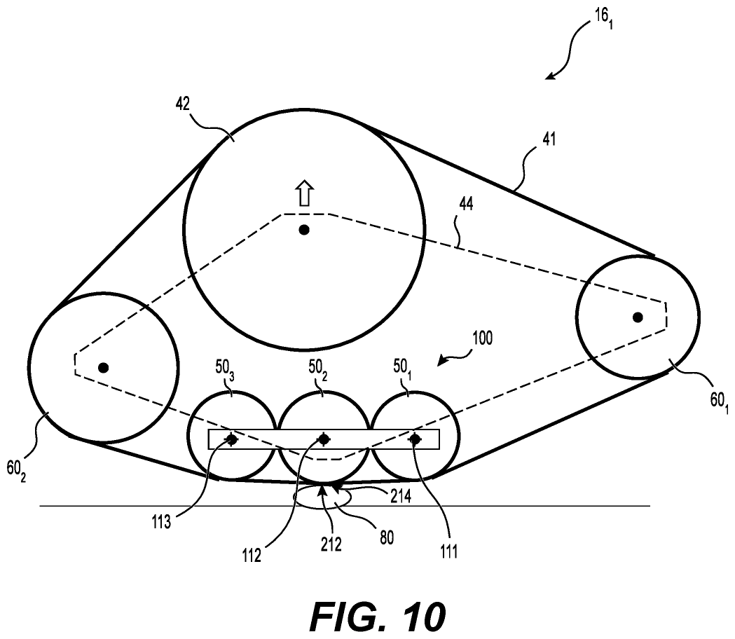

Referring now to FIG. 10, describing the operation of the bogie assembly 100 from FIG. 9 to FIG. 10, as the track system 16₁ travels in the forward direction, the rock 80 eventually reaches a point below the intermediate support wheel assembly 50₂. As this is happening, the bogie assembly 100 pivots clockwise until the initial position is reached. At this point, the rock 80 is in contact with the ground-engaging outer side 41ₒ of the endless track 41, below the intermediate support wheel assembly 50₂ such that the total ground force 214 is distributed in the intermediate ground force 212.

Referring now to FIG. 11, describing the operation of the bogie assembly 100 from FIG. 10 to FIG. 11, the track system 16₁ travels in the forward direction such the rock 80 eventually reaches the trailing support wheel assembly 50₃. As this is happening, the bogie assembly 100 pivots clockwise, such that the trailing support wheel assembly 50₃ moves in the upwards direction, and the leading support wheel assembly 50₁ moves in the downwards direction (as represented by the arrows in FIG. 11). At this point, the total ground force 214 is mostly distributed between the intermediate ground force 212 and the leading ground force 211.

Then, as the track system 16₁ continues to move in the forward direction, the rock 80 is just ending contact with the ground-engaging outer side 41ₒ of the endless track 41. This results in the bogie assembly 100 returning to the initial position, such that the trailing support wheel assembly 50₃ moves in the downwards direction. The trailing support wheel assembly 50₃ moving in the downwards direction causes the bogie assembly 100 to pivot counterclockwise, such that the leading support wheel assembly 50₁ moves in the upwards direction. Thus, eventually, the total ground force 214 is mostly distributed in the intermediate ground force 212.

As mentioned above, the magnitude of each of the leading ground force 211 and the trailing ground force 212 can vary in accordance with the distance ratio 130, with the rotational position of the bogie assembly 100 relative to the frame 44 and the tension in the endless track 41.

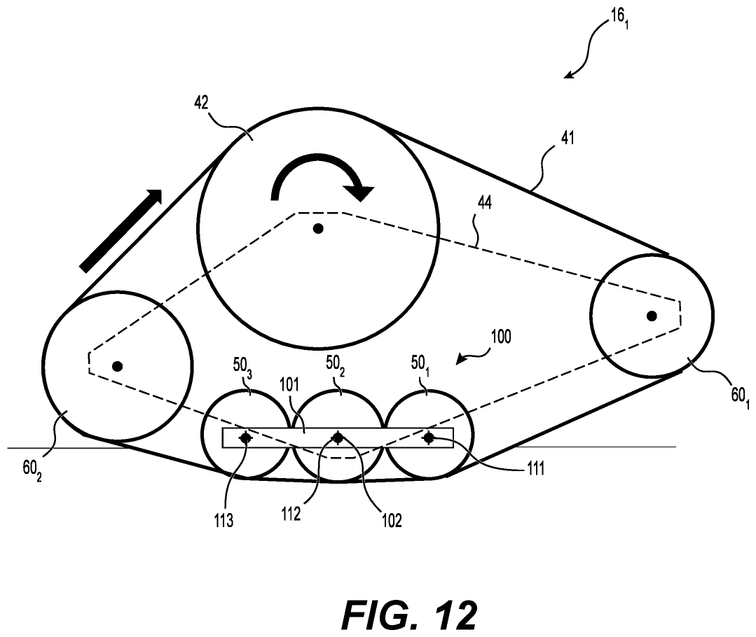

In another illustrative example referring to FIG. 12, the track system 16₁ is shown on a soft surface (ex. loose snow). A portion of the track system 16₁ has dug into the soft surface, but the front and rear idler wheel assemblies 60₁, 60₂ remain above the soft surface. In any case, when the ATV 10 accelerates, the magnitude of the leading ground force 211 is greater than the magnitude of the trailing ground force 213. In other words, due to the constant tension within the endless track 41, in part ensured by the tensioner 70, when a greater torque is applied to the drive wheel 42 (e.g. acceleration), the tension within the endless track 41 is momentarily higher between the rear idler wheel assembly 60₂ and the drive wheel 42, urging the track system 16₁ downwardly (“pointing down”) to reequilibrate the overall tension within the endless track 41, which in return increases the magnitude of the leading ground force 211 compared to the magnitude of the trailing ground force 213, at least in some cases, depending on the distance ratio 130 and the approach and departure angles AA, RA.

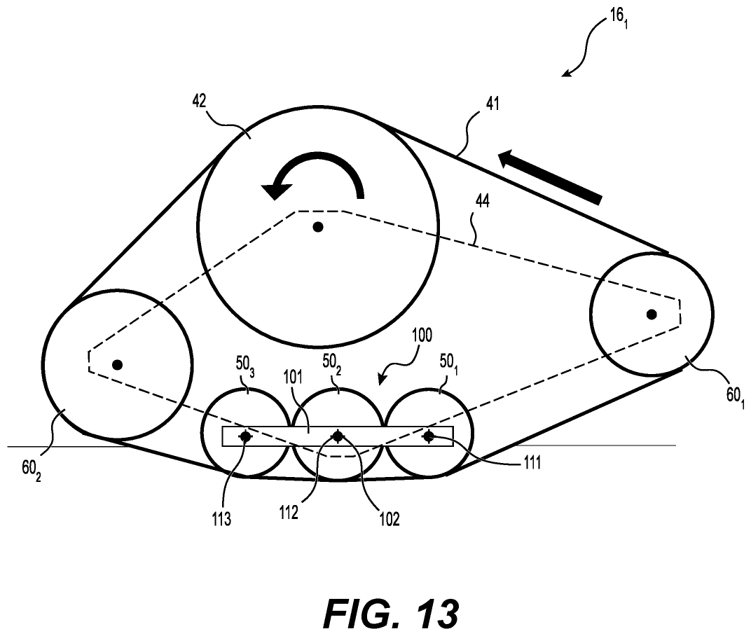

In contrast, referring to FIG. 13 where the track system 16₁ is also shown on a soft surface, when the ATV 10 decelerates, the magnitude of the leading ground force 211 is lower than the magnitude of the trailing ground force 213. In other words, due to the constant tension within the endless track 41, in part ensured by the tensioner 70, when a counter-torque is applied to the drive wheel 42 (e.g. deceleration or braking), the tension within the endless track 41 is momentarily higher between the front idler wheel assembly 60₁ and the drive wheel 42, urging the track system 16₁ upwardly (“pointing up”) to reequilibrate the overall tension within the endless track 41, which in return increases the magnitude of the trailing ground force 213 compared to the magnitude of the leading ground force 211, at least in some cases, depending on the distance ratio 130 and the approach and departure angles AA, RA.

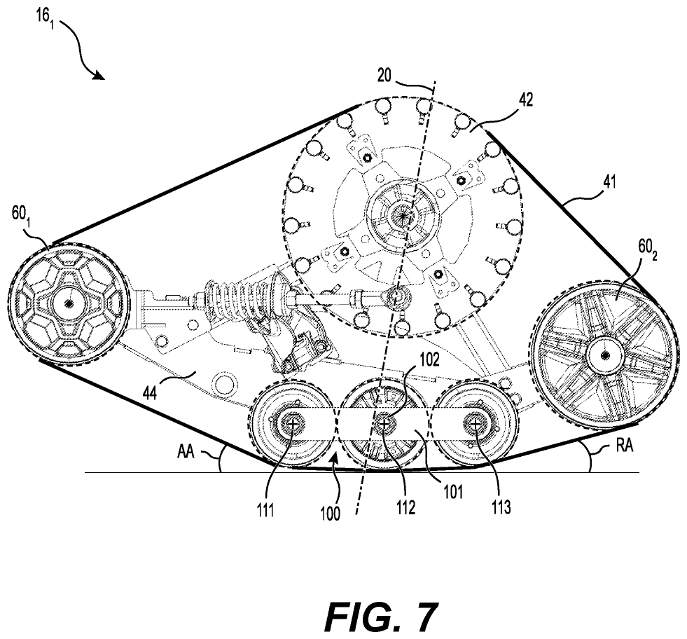

In some embodiments, the track system 16ᵢ is a track system steerable via the steerable system 17 of the vehicle 10 about the steering axis 20 to change the orientation of the track system 16ᵢ relative to the vehicle 10. In these cases, having a total ground force 214 concentrated at the intermediate ground force 212 (i.e. under the support wheel assembly 50₂) can reduce the steering effort. In these embodiments, the track system 16₁ can be configured such that the intermediate axis 112 may be longitudinally offset from a projection of the steering axis 20 to facilitate and/or stabilize the maneuverability of the track system 16ᵢ. For instance, in the present technology, the intermediate axis 112 is behind the projection of the steering axis 20, as shown on FIGS. 6 and 7.

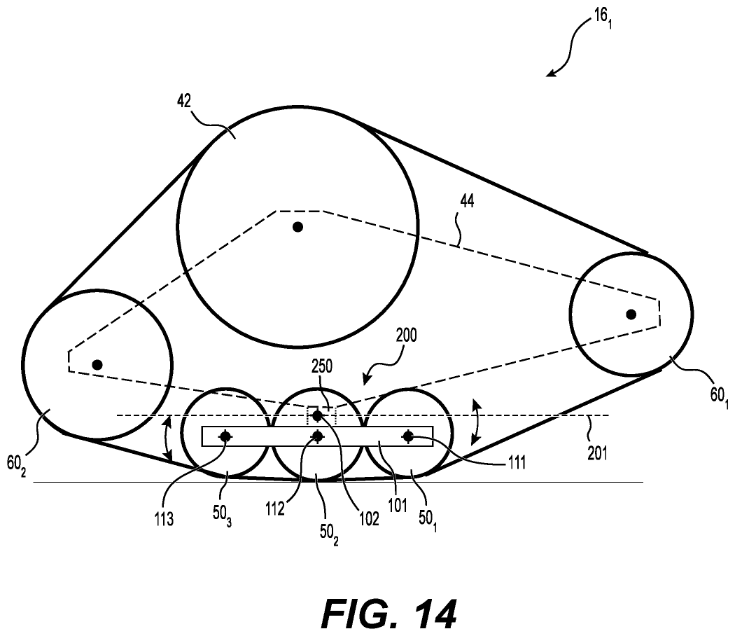

Referring to FIG. 14, an alternate embodiment of the bogie assembly 100, namely bogie assembly 200, will now be described in greater detail. Features of the bogie assembly 200 that are similar to the bogie assembly 100 have been labeled with the same reference numerals, and will not be described again in detail. The bogie assembly 200 is pivotally connected to the frame 44 about the bogie assembly axis 102, which in the present embodiment is vertically spaced from the intermediate axis 112, by a resilient body 250. It is contemplated that in some embodiments, the bogie assembly axis 102 could be coaxial with the intermediate axis 112. The resilient body 250 is configured such that the bogie assembly 200 is free to pivot about the bogie assembly axis 102 relative to the frame 44 upon deformation of the resilient body 250, as shown on FIG. 14. The pivotal motion can improve ride quality, while also aiding the track system 16₁ to overcome obstacles.

The resilient body 250 is formed of resilient material. The resilient body 250 can be molded and cured directly between the bogie assembly 200 and the frame 44, or configured to be connected to the frame 44 at one end and to the bogie assembly 200 at another end. The resilient body 250 can be connected permanently (e.g. overmolding, bonding, etc.) or removably (e.g. fastening, clamping, snaping, etc.). In some cases, the pivotal motion of the bogie assembly 100 relative to the frame 44 is guided (e.g. by stoppers, sidewalls, pin-slot, etc.) in such way that the pivotal motion of the bogie assembly 100 is about a transversal axis (e.g. the bogie assembly axis 102, the intermediate axis 112, or another axis) for allowing pitch-about oscillations. In such embodiments, the bogie assembly 100 has a limited range of roll-about motion, which may further assist in increasing the durability of the track system 16ᵢ under certain conditions.

The bogie assembly 200 and the resilient body 250 are further configured such that, in part due to the resilient nature of the resilient body 250, the bogie assembly 200 is free to pivot about a longitudinal axis 201 relative to the frame 44. Thus, the bogie assembly 200 is free to pivot three degrees clockwise and three degrees counterclockwise in the roll motion about the longitudinal axis 201. It is contemplated that in other embodiments, the bogie assembly 200 could have a range of motion of more or less than three degrees in either direction. In some embodiments, the bogie assembly 200 could be guided using suitable components (e.g. by stoppers, sidewalls, pin-slot, etc.). In yet other embodiments, the bogie assembly 200 and the resilient body 250 could be configured to not pivot about the longitudinal axis 201. In yet other embodiments, the bogie assembly 100 could have a limited range of motion in the pitch, which could increase the durability of the track system 16₁.

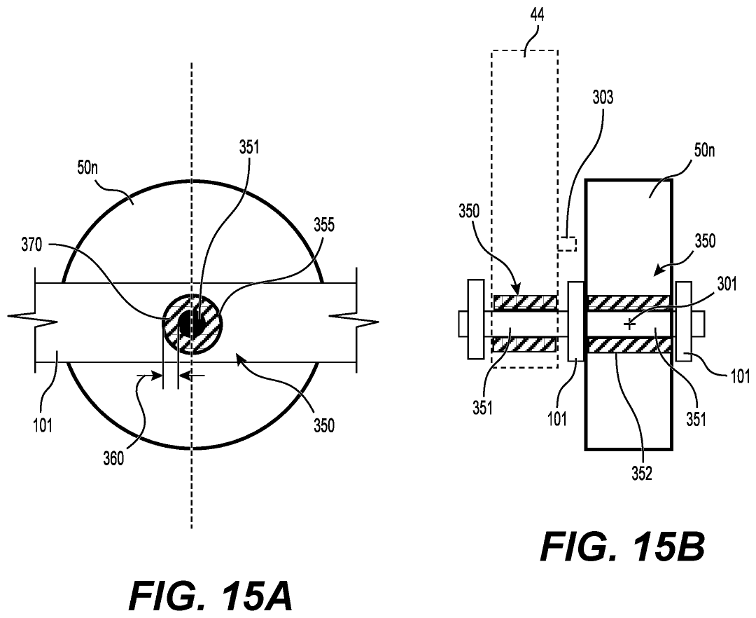

Referring to FIGS. 15A and 15B, an alternate embodiment of the bogie assembly 100, namely bogie assembly 300, will now be described in greater detail. Features of the bogie assembly 300 that are similar to the bogie assembly 100 have been labeled with the same reference numerals, and will not be described again in detail. At least one of the leading, intermediate and trailing support wheel assemblies 50₁-50₃ (represented in FIGS. 15A-15B as support wheel assembly 50ₙ) is rotationally connected to the bogie assembly 300 by resilient pivots 350. It is contemplated that in other embodiments, more than one of the leading, intermediate and trailing support wheel assemblies 50₁-50₃ could be connected to the bogie assembly 300 by the resilient pivots 350. The resilient pivot 350 is configured such that the support wheel assembly 50ₙ is free to pivot relative to the bogie assembly 300 in a roll motion about longitudinal axis 301, as shown in FIG. 15B. The support wheel assembly 50ₙ has a range of motion of three degrees in the clockwise and counterclockwise directions. In the present embodiment, the range of motion is limited by a stopper 303 connected to the frame 44. It is contemplated that in some embodiments, the stopper 303 could be omitted. In some embodiments, each of the resilient pivots 350 includes a male-part 351 (e.g. pin, shaft, etc.) received in a female-part 355 (e.g. bore, hole, cavity, etc.), and a spacing 360 defined between at least a portion of the male-part and at least a portion of the female-part, where the spacing 360 is filled with a resilient material, such as rubber, forming a resilient connection 370 between the male-part 351 and the female-part 355, such that the pivotal motion of said male-part 351 relative to said female-part 355 is resiliently biased upon the deformation of the resilient material therebetween. In the present embodiment, the male-part 351 is also connected to the frame 44 by the resilient pivot 350, such that the male-part 351 is free to pivot relative to the frame 44. Other configurations of resilient pivot 350 are contemplated.

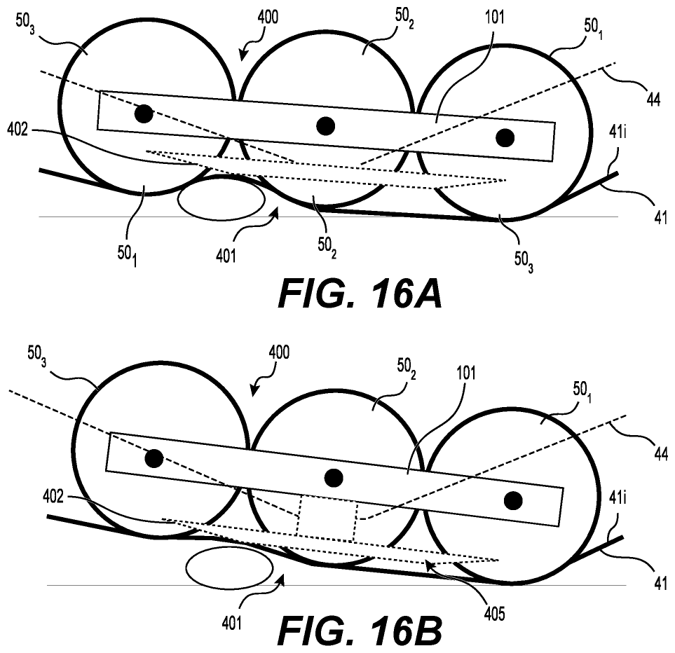

Referring to FIGS. 16A and 16B, an alternate embodiment of the track system 16₁ and the bogie assembly 100, namely bogie assembly 400, will now be described in greater detail. Features of the bogie assembly 400 that are similar to the bogie assembly 100 have been labeled with the same reference numerals, and will not be described again in detail. In the present embodiment, the track system 16ᵢ further includes a slide member 401 that is adjacent to the leading, intermediate and trailing support wheel assemblies 50₁-50₃ and that is spaced from the inner side 41ᵢ of the endless track 41 by a gap 405, as shown in FIG. 16B.

The slide member 401 has an elongated body 402 and is made from a wear resistant material that has a relatively low coefficient of friction with the inner side 41ᵢ of the endless track 41, such as UHMW or HDPE. By default, the slide member 401 is configured and disposed in such way that the slide member 401 is not in constant contact with the inner side 41ᵢ of the endless track 41 and is aligned with the longitudinal direction of the track system 16₁. As shown in FIGS. 16A and 16B, the slide member 401 contacts the inner side 41ᵢ of the endless track 41 when the track system 16₁ travels on uneven terrain and/or encounters an obstacle, especially when a given one of the leading, intermediate and trailing support wheel assemblies 50₁-50₃ has rolled over an obstacle and another one of the leading, intermediate and trailing support wheel assemblies 50₁-50₃ is about to roll over said obstacle, to minimize the impact with the other one of the plurality of support wheel assemblies 50₁-50₃, which may cause ride discomfort and premature wear of the track system 16₁ under certain circumstances. In other words, the slide member 401 acts as a bridge or a stopper between at least two adjacent support wheel assemblies 50₁-50₃, to minimize the depth in which an obstacle may penetrate between at least two adjacent support wheel assemblies 50₁-50₃ as shown in FIG. 16A. When the endless track 41 contacts the slide member 401, the endless track 41 is guided by the slide member 401, instead of being deeply deformed locally between two adjacent support wheel assemblies 50₁-50₃, which attenuates shocks as well as the resulting wear and tear. In some embodiments, the elongated body 402 has upwardly curved or angled ends for ensuring a smooth contacting transition of the endless track 41 with the slide member 401, reducing friction and wear of the slide member 401 and/or the endless track 41. At least in some cases, the slide member 401 contributes to maintaining good traction of the track system 161 on uneven ground surfaces.

In some embodiments, the slide member 401 is connected to the frame 44, the connection between the slide member 401 and the frame 44 being permanent (e.g. bonding, overmolding, etc.) or removable (e.g. fastening, clamping, etc.). In these cases, the slide member 401 can move relative to the pivoting bogie assembly 100.

In some embodiments, the slide member 401 is connected to the bogie assembly 400, the connection between the slide member 401 and the bogie assembly 100 being permanent (e.g. bonding, overmolding, etc.) or removable (e.g. fastening, clamping, etc.). In these cases, the slide member 401 is pivotal relative to the frame 44 and fixed relative to the bogie assembly 100.

It is understood that when the track system 16₁ travels on soft surfaces (e.g. snow, mud, sand, etc.) the distribution of the total ground force 214 may differ from what has been described herein, at least in some circumstances. As a person skilled in the art will understand, soft surfaces or grounds vary in density, bearing capacity, compactness, etc. and have tendency to reshape when the track system 16₁ travels over them due to the load applied to them. Floatation becomes a determinant factor for the overall performances of the track system 16₁, combined with traction. The present technology is optimized to meet both requirements, i.e. a quasi-punctual ground force applied on a hard surface mimicking a wheel in order to reduce friction and thus reduce the steering effort required for changing the orientation of the track system 16₁ relative to the ATV 10, and a good floatation on a soft surface due to the layout of the track system 16₁ that allows a contact surface with the ground that is large enough to ensure a good distribution of the ground force while being lightweight. Furthermore, the present technology, in part due to the pivotal motion of the bogie assemblies 100, 200, 300, 400 can aid the track system 16₁ to better conform to the asperities of the ground surface, enhancing the traction, the ride quality and the maneuverability of the track system.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A track system configured to be operatively connectable to a vehicle, the track system defining a longitudinal center plane and being operable on a ground surface, and comprising:
a track-engaging assembly including:
a frame having a front portion, a rear portion, and a lower portion extending vertically below at least one of the front and rear portions;
a drive wheel rotationally connected to the frame;
a front idler wheel assembly rotationally connected to the front portion of the frame;
a rear idler wheel assembly rotationally connected to the rear portion of the frame; and
a bogie assembly pivotably connected to the lower portion of the frame about a bogie assembly axis extending transversally to the longitudinal center plane, and having a bogie body defining a leading axis, an intermediate axis and a trailing axis, the leading, intermediate and trailing axes extending transversally to the longitudinal center plane and being longitudinally spaced from each other; and
a plurality of support wheel assemblies including:
a leading support wheel assembly rotationally connected to the bogie body for rotating about the leading axis, the leading support wheel assembly applying a leading ground force to the ground surface;
an intermediate support wheel assembly rotationally connected to the bogie body for rotating about the intermediate axis, the intermediate support wheel assembly applying an intermediate ground force to the ground surface; and
a trailing support wheel assembly rotationally connected to the bogie body for rotating about the trailing axis, the trailing support wheel assembly apply a trailing ground force to the ground surface;
a sum of the leading, intermediate and trailing ground forces defining a total ground force applied to the ground surface by the track system; and
an endless track disposed around the track-engaging assembly, the endless track having a ground-engaging outer side for engaging the ground surface and an inner side opposite to the ground-engaging outer side, the endless track being configured to be drivingly engaged by the drive wheel;
the track system having an initial position wherein the total ground force is generally concentrated at the intermediate ground force in response to the track system being at rest on a generally hard and flat level ground surface; and
in response to the bogie assembly pivoting about the bogie assembly axis, the total ground force is distributed between the intermediate ground force and at least one of the leading and trailing ground forces in response to the track system travelling on a generally hard and uneven ground surface.

2. The track system of claim 1, wherein the bogie assembly is pivotably connected to the frame such that the bogie assembly axis is coaxial with the intermediate axis.

3. The track system of claim 1, wherein a diameter of a wheel of the intermediate support wheel assembly is greater than a diameter of a wheel of at least one of the leading and trailing support wheel assemblies.

4. The track system of claim 1, wherein the intermediate axis is vertically lower than at least one of the leading axis and trailing axis.

5. The track system of of claim 1, wherein at least one of the leading, intermediate and trailing support wheel assemblies includes more than one wheel assembly in a direction transversal to the endless track.

6. The track system of of claim 1, wherein the leading axis and the trailing axis are respectively spaced from the intermediate axis by a first distance and a second distance.

7. The track system of claim 6, wherein a distance ratio of the first distance over the second distance is 1.

8. The track system of claim 6, wherein a distance ratio of the first distance over the second distance is smaller than 1.

9. The track system of claim 6, wherein a distance ratio of the first distance over the second distance is greater than 1.

10. The track system of claim 6, wherein the total ground force is distributed between the leading ground force and the trailing ground force according to a distance ratio of the first distance over the second distance, in response to the leading support wheel assembly climbing on an obstacle of the ground surface or in response to the trailing support wheel assembly descending an obstacle of the ground surface.

11. The track system of claim 1, wherein:
a magnitude of the leading ground force is greater than a magnitude of the trailing ground force in response to the vehicle accelerating; and
the magnitude of the leading ground force is lower than a magnitude of the trailing ground force in response to the vehicle decelerating.

12. The track system of claim 1, wherein in the initial position, the front idler wheel assembly and the rear idler assembly are positioned vertically above the hard and flat level ground surface.

13. The track system of claim 1, wherein an approach angle between the endless track and the hard and flat level ground surface in front of the leading support wheel assembly is substantially equal to a departure angle between the endless track and the hard and flat level ground surface behind the trailing support wheel assembly.

14. The track system of claim 1, further comprising a slide member extending adjacent to the plurality of support wheel assemblies, the slide member being spaced from the inner side of the endless track by a gap.

15. The track system of claim 14, wherein the slide member is connected to one of the frame and the bogie assembly.

16. The track system of claim 1, wherein the bogie assembly is pivotably connected to the frame via a resilient body configured for permitting pivotal motion of the bogie assembly relative to the frame upon deformation of the resilient body.

17. The track system of claim 16, wherein the pivotal motion of the bogie assembly relative to the frame is about one of: a transversal axis and a longitudinal axis.

18. The track system of claim 1, wherein at least one of the leading, intermediate and trailing support wheel assemblies is rotationally connected to the bogie assembly via a resilient pivot structured and configured for permitting pivotal motion of at least one of the leading, intermediate and trailing support wheel assemblies relative to the bogie assembly about a longitudinal axis.

19. The track system of claim 18, wherein an angular range of the pivotal motion of the at least one of the leading, intermediate and trailing support wheel assemblies relative to the bogie assembly is at least 3 degrees.

20. A vehicle comprising:
a frame;
an engine supported by the frame;
at least two track systems according to claim 1 operatively connected to the engine.
